(19) United States
(12) Patent Application Publication
(10) Pub. No.: US 2013/0140822 A1
(43) Pub. Date: Jun. 6, 2013

(54) FLUID POWER DRIVEN CHARGER

(71) Applicant: Fabio SAPOSNIK, Markham (CA)

(72) Inventor: Fabio SAPOSNIK, Markham (CA)

(21) Appl. No.: 13/705,541

(22) Filed: Dec. 5, 2012

Related U.S. Application Data
(60) Provisional application No. 61/566,794, filed on Dec. 5, 2011.

(51) Int. Cl. H02K 13/00

(52) U.S. Cl. CPC H02K 13/00
USPC 290/50

(57) ABSTRACT

A system and method for charging a battery in a fluid power driven attachment to heavy equipment is provided. A battery charger comprises a motor for receiving fluid power from a fluid power system of the heavy equipment; an alternator, dynamo or generator driven by the motor; a charge control system and optionally, a battery for the hydraulic attachment. The motor may be controlled to operate in response to at least one of a condition of the fluid power received and an operative status of a fluid power driven device of the attachment. The charge control system may limit and/or regulate a voltage received from the alternator, dynamo or generator. The fluid power driven attachment may be configured with the fluid power driven battery charger as a component thereof.

### TECHNICAL FIELD

The present disclosure relates to electric power sources, for example, for hydraulic or pneumatic (i.e. fluid power driven) attachments to heavy equipment and more particularly to a fluid power driven charger for charging energy storage devices (e.g. a battery or a supercapacitor) for such attachments.

### BACKGROUND

It is common for heavy equipment machines, such as a vehicle 102 (FIG. 1), to generate their own electricity: a vehicle engine 106 turns a vehicle alternator 108, which in turn charges a vehicle battery 112 via a vehicle charge control system 110. Vehicle battery 112 is the power source for certain electrical needs of vehicle 102 such as one or more vehicle control systems 114. Fluid power driven attachments (e.g. hydraulic attachment 202) for such vehicles may include grading blades or trenchers attached to excavators, delimbers or harvesters attached to logging machines, etc. Fluid power driven attachments that are fed hydraulic or pneumatic power from a fluid power system (e.g. hydraulic system 104) of vehicle 102, also need electric power for control purposes. The term “fluid power” is used herein in reference the use of fluids under pressure to generate, control or transmit power, whether ultimately such fluid power is hydraulic or pneumatic.

It is known to provide electric power for hydraulic attachment 202 from vehicle 102 via cabling (e.g. to an attachment control system 212) or by having a removable battery 205 on hydraulic attachment 202. Electric cables suffer because they break easily in the heavy equipment environment; removable battery 205 is inconvenient, because it needs to be removed in order to charge it—typically once a day, if not more often.

An electric power solution for the fluid power driven attachment which lessens the impact of one or more of these issues is desirable.

### SUMMARY

There is provided a fluid power driven charger and a method for charging an energy storage device. A fluid power driven charger for a fluid power driven attachment to heavy equipment comprises: an electric power generation device for receiving fluid power from a fluid power system of the heavy equipment and for outputting electric power; and a charge control system for charging an energy storage device from the electrical power.

The electric power generation device may comprise a motor driven by the fluid power. The electric power generation device may further comprises one of an alternator, dynamo or generator driven by the motor for outputting the electrical power.

The charger may further comprise a power generation control system configured to operate the electric power generation device in response to at least one of a condition of the fluid power received and an operative status of a fluid power driven device of the fluid power driven attachment. The power generation control system may be configured to monitor at least one of fluid pressure and flow rate and turn off the electric power generation device in accordance with one or more preselected thresholds. The power generation control system may be configured to operate the electric power generation device when the operative status is idle. The charger may comprise a selector valve to control the fluid power to the electric power generation device, The selector valve may selectively direct fluid power to either one of: the fluid power driven device on the fluid power driven attachment, the electric power generation device directly, or the electric power generation device through the power generation control system.

The charger may further comprising the energy storage device. The energy storage device may comprise one or more of a battery and a supercapacitor.

The charge control system may be configured to regulate a voltage of the electrical power received. The charge control system may be configured to cease charging the energy storage device when a voltage of the electrical power received is below a preselected threshold.

The charger may further comprise a power feed for the fluid power driven attachment. The charger may be configured as a component of the fluid power driven attachment.

A method of charging an energy storage device of a fluid power driven attachment to heavy equipment comprises: receiving fluid power from a fluid power system of the heavy equipment; operating a electric power generation device to provide electric power; and charging the energy storage device from the electric power.

In another embodiment, there is provided a fluid power driven attachment for heavy equipment wherein the fluid power driven attachment receives fluid power from the heavy equipment. The fluid power driven attachment is configured to charge an energy storage device for the fluid power driven attachment via one of an alternator, dynamo or generator driven by a motor using the fluid power received.

### BRIEF DESCRIPTION OF FIGURES

For brevity, a hydraulic power based implementation of a fluid power driven charger for a battery is primarily shown and described in which:

FIG. 1 is a block diagram of a vehicle and hydraulic attachment where, in accordance with the prior art, electric power for control the hydraulic attachment is provided by cabling from the vehicle in one embodiment or a removable battery for the hydraulic attachment in another embodiment;

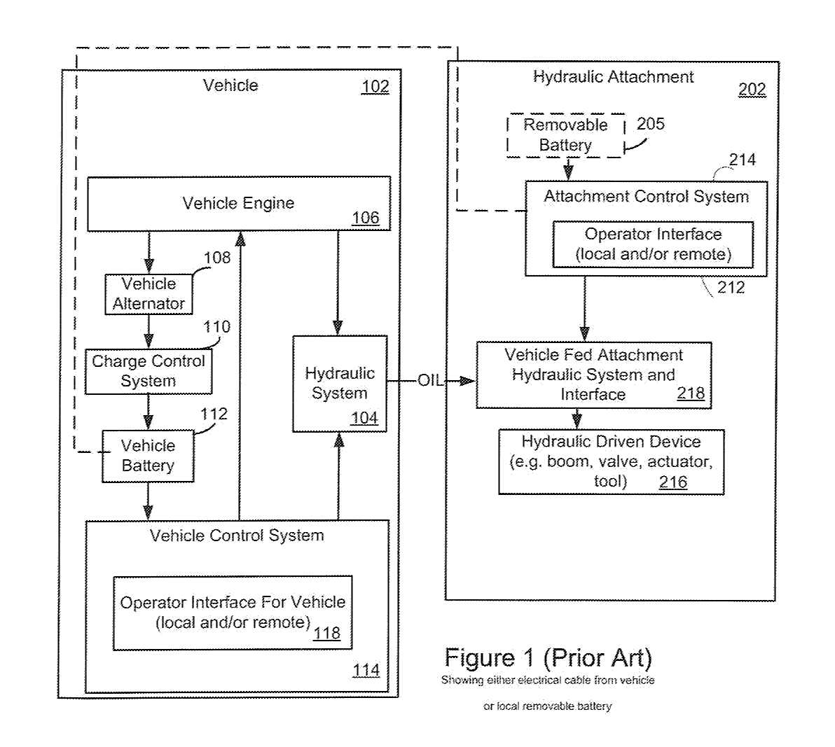

FIG. 2 is a block diagram that shows an example embodiment, adapted in accordance with the teachings herein, of a vehicle and a hydraulic attachment where electric power for control of the hydraulic attachment is provided by a battery for the hydraulic attachment which is rechargeable by the vehicle's hydraulic system; and

FIG. 3 shows a portion of FIG. 2 in more detail.

Like reference numerals indicate like parts throughout the diagrams.

### DETAILED DESCRIPTION

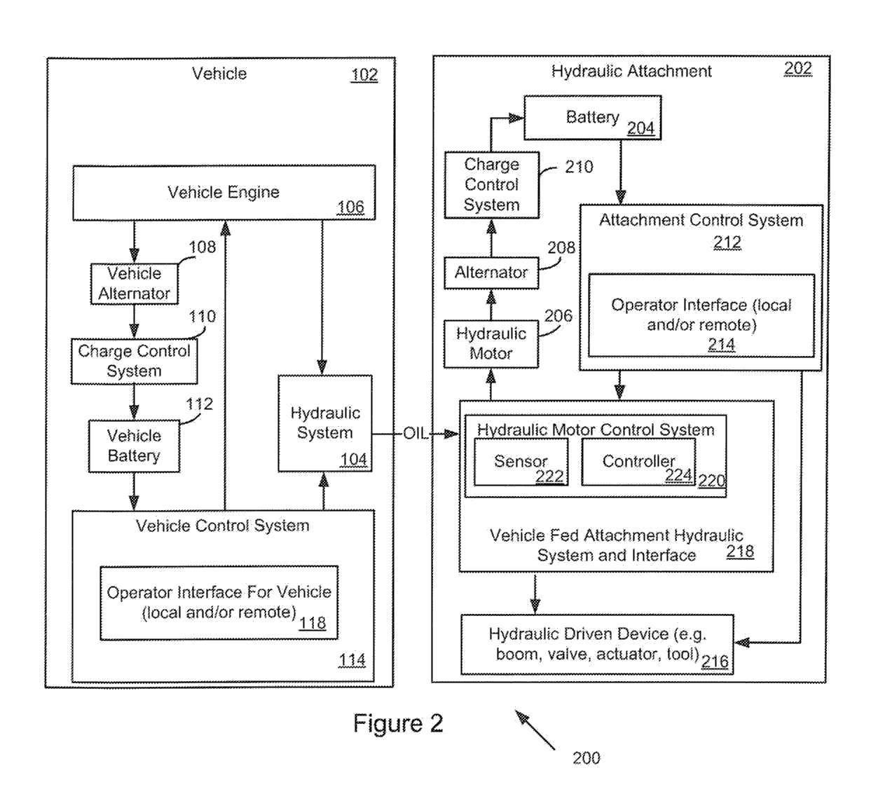

FIG. 2 is a block diagram 200 that shows an example embodiment of a vehicle 102 and a hydraulic attachment 202, adapted in accordance with the teachings herein, having a rechargeable power source. That is, electric power such as for controlling of the hydraulic attachment 202 is provided by a battery 204 on or within the hydraulic attachment 202, which is rechargeable by fluid power from the hydraulic system 104.

The hydraulic attachment 202 is provided with a hydraulic motor 206 connected to the hydraulic-oil flow (“OIL”) provided by hydraulic system 104. Connection may be via one or more sturdy hoses, valves, gauges, and other applicable infrastructure, at least some of which is configured as a component of attachment 202, such as vehicle fed attachment hydraulic system 218. Vehicle fed attachment hydraulic system 218 also connects hydraulic driven device 216 to hydraulic system 104. It is appreciated that vehicle fed attachment hydraulic system 218 is simplified in FIG. 2.

Hydraulic motor 206 is connected to drive an alternator 208, which in turn is connected to a charge control system 210 for the battery 204. Battery 204 provides power to attachment control system 212 having an operator interface 214 for controlling a hydraulic driven device 216 provided by the hydraulic attachment 202. Control may be via vehicle fed attachment hydraulic system and interface 218, or directly, or both, as the case may be. It is understood that battery 204 may also provide power (and be connected to) other components (not shown), such as components of hydraulic attachment 202.

It is understood that vehicle 102 comprises a vehicle engine 106, a vehicle alternator 108, vehicle charge control system 110 and vehicle battery 112. Vehicle battery 112 may provide electric power for vehicle control system 114 configured for controlling the vehicle engine 106 and/or hydraulic system 104. Vehicle control system 114 may have a vehicle operator interface 118. In many heavy equipment vehicles having hydraulic systems, it is contemplated that one or more vehicle fed hydraulic attachments may be employed. Such attachments are often mounted to the vehicle and applicable hose or hoses are attached to an interface for hydraulic system 104. In the present embodiment a single oil flow is illustrated between hydraulic system 104 and hydraulic attachment 202. Though not illustrated, a specific dedicated flow of hydraulic oil from hydraulic system 104 may be provided to hydraulic motor 206.

It is understood that vehicle 102 may be a stationary machine; also, vehicle 102 may lack one or more of the elements depicted in FIG. 2, without altering materially the system and method described herein. For example, hydraulic system 104 may be driven by an electric motor, which in turn may be powered by a battery system, from the power grid, or from other sources.

It understood that one or more of subsystems and components 204, 206, 208, 210, 212, 214, 216, and 218 of attachment 202 may be on a structure (not shown) separate from and adjacent to attachment 202 provided that the motion of said structure relative to attachment 202 is restricted such that any connections between the two is not unduly exercised; the motion of said structure relative to vehicle 102 may be significantly less restricted, in particular if OIL is provided through a hydraulic swivel (not shown).

It is understood that the method and system described include energy transfer by means of hydraulic oil from hydraulic system 104 to hydraulic attachment 202; the system and method described would not be materially altered if a different medium was used to transfer energy; for example, the system could be built using pneumatic power, such that energy would be transferred by means of a compressed gas or mix of gasses from vehicle 102 to attachment 202.

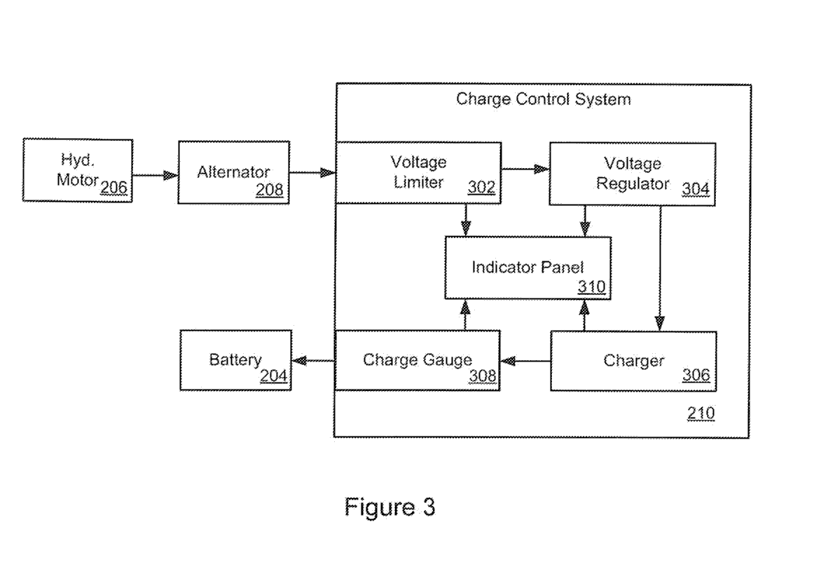

FIG. 3 shows portions of FIG. 2 in detail. In the example embodiment, charge control system 210 comprises a voltage limiter 302, voltage regulator 304 (to account for the range over which the alternator operates and its supply), charger 306 and charge gauge 308 as well as indicator panel 310. It is understood that one or more of 302, 304 and 310 may be built into alternator 208. Charge control system 210 may be configured to selectively charge battery 204 and may be responsive to one or more preselected thresholds.

Voltage limiter 302 protects the other elements (e.g. 304, 306, 308 and 310) of the charge control system 210 and the battery 204 from over-voltage and under-voltage conditions in the output of the alternator 208; voltage regulator 304, which may be a DC-to-DC converter, maps the output of the alternator 208 to a voltage range within which charger 306 can operate; charge gauge 308 measures the charge in and out of the battery 204 and displays that information either directly or through indicator panel 310.

It is understood that hydraulic attachment 202 may be configured such that hydraulic motor 206 is operated to run and charge the battery 204 when the hydraulic driven device 216 is idle, in operation, or either of these times. In some embodiments, oil pressure from hydraulic system 104 may not be sufficient to operate hydraulic driven device 216 and motor 206 simultaneously. Hydraulic attachment 202 (e.g. hydraulic motor control system 220) may comprise one or more sensors 222 for monitoring hydraulic oil pressure and/or flow rate and a controller 224 for hydraulic motor 206 to turn hydraulic motor 206 on or off accordingly. Similarly hydraulic attachment (e.g. hydraulic motor control system 220) may be configured to control the operation of motor 206 in response to the operation/idle status of device 216 and/or one or more preselected thresholds. For example, hydraulic motor control system 220 may monitor control signals from attachment control system 212. Preselected thresholds may relate to oil flow and pressure from hydraulic system 104, etc.

It is understood that attachment control system 212 may be operated by signals from the operator interface 214, by signals from operator interface 118, or remotely by a remote control unit (not shown).

In one embodiment, hydraulic motor 206 is connected in series with a valve (e.g. within component 218 (but not shown)), which can be shut off by the controller 224 when battery 204 is fully charged or when the OIL is needed to run the hydraulic driven device 216. This valve may be e.g. an electrically actuated single-inlet/single-outlet valve. This approach is energy efficient, especially if the valve requires electric power, e.g. from controller 224, to cause the motor to turn. The disadvantage of this approach is that the battery needs an initial charge, enough to power the valve and, potentially, controller 224. Conversely, if when the valve is not powered it causes the motor to turn, the battery does not need an initial charge—but when the motor is not running the valve needs to be energized and the battery will be drawn down, so this is less energy efficient.

In another embodiment, there is no such valve, and hydraulic motor 206 always turns—but when the battery 204 is fully charged the charge control system (210) demands only a small amount of power, since it will only be supplying a low voltage (commonly called the float voltage) to maintain the battery charge. So, hydraulic motor 206 will turn, but it will not be loaded, and therefore the amount of work it will do, and the amount of energy it will consume, will be significantly reduced.

In yet another embodiment the valve is a selector valve, which can supply hydraulic-oil flow selectively to one of hydraulic motor 206 and hydraulic driven device 216. The operation of said selector valve may be controlled by controller 224.

It is understood that hydraulic motor control system 220 may be implemented simply by means of an on/off switch, operated manually. This applies whether there is a valve or not, and whether the valve is connected in series or as a selector valve.

To choose a suitable hydraulic motor 206, an implementer may look at: the speed at which alternator 208 needs to turn for it to be useful, e.g. between 200 RPM and 1000 RPM; how much power is needed out of alternator 208 (e.g. if battery 204 is to be charged with a current I=2.5 Amps, a charging voltage V=16V, and with a combined efficiency of charge control system 210 and alternator 208 of n=0.6, then the output power required from hydraulic motor 206 would be: P=2.5 A*16 V/0.6=67 Watts˜=3/32 HP. Thus the implementer may review what hydraulic motor 206 can deliver this power and the minimum speed the alternator 208 requires, given the flow rate available from the hydraulic system 104.

The implementer may consider further constraints. The minimum power that hydraulic motor 206 delivers, as set by the minimum flow rate and pressure available from hydraulic system 104, will determine whether battery 204 can be charged at the desired rate. If the power falls below this number, battery 204 may still charge, but more slowly. The maximum power that hydraulic motor 206 can deliver will determine whether alternator 208 will output excessive voltage; if this maximum voltage is higher than the charger 306 can tolerate, then a means are necessary (e.g. voltage limiter 302 and/or switch within charge control system 210) to disconnect charger 306 from alternator 208 if a certain voltage threshold is reached. For example, charger 306 may be protected up to an input voltage of 40V. If a alternator 208 comprising permanent magnets is used, (e.g. built with a rare-earth magnet rotor), the output voltage could exceed 100V at its top speed. (A magnet based alternator may be preferred over a wound rotor based alternator.) A switch may be employed to disconnect charger 306 to protect from this eventuality.

The maximum rotation speed of alternator 208, determined by how it is constructed, may need to be considered when selecting a hydraulic motor 206 so that the output of such motor would not operate alternator 208 above this limit.

Hydraulic motor 206 is preferably capable of carrying the maximum output flow and pressure of hydraulic system 104, without failing or causing excessive pressure drop and heat dissipation. If this requirement is not practicable, e.g. due to hydraulic motor 206 size or cost constraints, vehicle fed attachment hydraulic system and interface 218 may include a valve as described above, which would cut off oil supply to hydraulic motor 206 if the hydraulic oil flow rate and/or pressure approached the maximum operating specifications of hydraulic motor 206.

Hydraulic attachment 202 (e.g. components such as charge control system 210 and/or vehicle fed attachment hydraulic system and interface 218) may be configured to charge battery 204; to increase (boost) the input voltage to charger 306 (if alternator 208 is turning slowly, its output can be less than the voltage of battery 204); to deal with the possibility of excessive output of alternator 208; and to turn charging operations on and off e.g. based on whether the attachment hydraulic driven device 216 is in use, whether the vehicle hydraulics or the attachment hydraulics are keeping up to desired operating parameters, and whether the alternator output is excessive.

The hydraulic battery charger may be implemented using one or more of analog hardware, digital hardware, and a micro-controller-based subsystem. An example embodiment of the system logic when hydraulic power is available is as follows:
While hydraulic charger is enabled by user
   Monitor battery condition
While battery present and not faulty and battery temperature within bounds
   Battery can be charged.
While battery can be charged
   Check hydraulic power
   While hydraulic power is present and pressure and flow within bounds
      Check hydraulic driven device status
      While hydraulic driven device is inactive
         Activate the fluid power driven charger
While fluid power driven charger is active
   Activate hydraulic motor
   Monitor alternator output
      While alternator output is within bounds
         Enable voltage regulator
         While voltage regulator output within bounds.
         Charge battery using appropriate algorithm
         Evaluate battery charge
         Display percentage battery charge remaining
Display state of alternator, voltage limiter, voltage regulator and charger
   While battery fully charged or fault condition exists or system disabled
   De-activate hydraulic motor
   While system is disabled
   Power charger subsystems down

As illustrated, the components of FIG. 3 are preferably configured as components of hydraulic attachment 202. In an alternative embodiment, not shown, at least some of the components (e.g. 204, 206, 208, 210 and 220) could be located in vehicle 102 and one or more power cables run between battery 204 and attachment control system 212. In many heavy equipment hydraulic vehicle configurations, such as excavators, the vehicle has a vehicle engine (and often a cab for the operator) mounted on a platform, which is mounted on a large bearing that can rotate indefinitely. The bearing is mounted on a carrier for movement along the ground or other surface, which carrier could have two tracks or four tires, for example. At the center of the bearing there is often mounted a hydraulic swivel, which allows passage of hydraulic oil in both directions. The hydraulic attachment is typically mounted to the carrier, below the bearing, making it difficult to run wires to the hydraulic attachment 202 from the vehicle alternator 108 and/or vehicle battery 112, which is mounted above the bearing: if the rotation of the machine is not limited, and it usually is not, then any such wires would be torn after a few rotations of the upper body of the vehicle 102. If the components are mounted below the bearing such that they do not rotate, the components need not be on the hydraulic attachment 202 per se.

Persons of skill in the art will appreciate that certain components described herein (such as 206, 208 and 210) may be configured as a hydraulic battery charger for a battery for hydraulic attachment 202. The hydraulic battery charger may further comprise hydraulic motor control system 220 and/or battery 204. The hydraulic battery charger may be configured as a component of hydraulic attachment 202. In another configuration, hydraulic battery charger may be configured for mounting to heavy equipment with a power feed line for the hydraulic attachment such that there is not indefinite rotation of the hydraulic battery charger relative to the heavy equipment.

Persons of skill in the art appreciate that the hydraulic battery charger may be configured as a pneumatic battery charger by replacing some or all hydraulic components with pneumatic components. For example, hydraulic motor 206 may be replaced with a compressed-air powered rotary machine, configured to turn alternator 208.

Though alternator 208 is shown, a dynamo or generator may be used.

Persons of skill in the art may construct an electric power generation device to replace both hydraulic motor 206 and alternator 208, having as its input the flow of either hydraulic oil or a gas, compressed or otherwise, and as its output electric power, without materially altering the system and method disclosed herein.

The fluid power driven charger may be implemented using a supercapacitor instead of battery 204 as an energy storage device; in such a case, voltage regulator 304 and charger 306 may be replaced e.g. by a voltage-limited current source, to ensure the capacitor is optimally charged without damage.

1. A fluid power driven charger for a fluid power driven attachment to heavy equipment, the battery charger comprising:
an electric power generation device for receiving fluid power from a fluid power system of the heavy equipment and for outputting electric power; and
a charge control system for charging an energy storage device from the electrical power.

2. The charger of claim I wherein the electric power generation device comprises a motor driven h the fluid power,

3. The charger of claim 2 wherein the electric power generation device further comprises one of an alternator, dynamo or generator driven by the motor for outputting the electrical power.

4. The charger of claim I further comprising a power generation control system configured to operate the electric power generation device in response to at least one of a condition of fluid power received and an operative status of a fluid power driven device of the fluid power driven attachment.

5. The charger of claim 4 Wherein the power generation control system is configured to monitor at least one of fluid pressure and flow rate and turn off the electric power generation device in accordance with one or more preselected thresholds.

6. The charger of claim 4 wherein the power generation control system is configured to operate the electric power generation device when the operative status is idle.

7. The charger of claim 4 comprising a selector valve to control the fluid power to the electric power generation device said selector valve selectively directing fluid power to either one of the fluid power driven device on the fluid power driven attachment, the electric power generation device directly, or the electric power generation device through the power generation control system.

8. The charger of claim 1 further comprising the energy storage device.

9. The charger of claim 1 wherein the charge control system is configured to regulate a voltage of the electrical power received,

10. The charger of claim 1 wherein the charge control system is configured to cease charging the energy storage device when a voltage of the electrical power received is below a preselected threshold.

11. The charger of claim 1 comprising a power feed for the attachment.

12. The charger of claim 1 configured as a component of the fluid power driven attachment.

13. The charger of claim 1 wherein the energy storage device comprises one of a battery and a supercapacitor.

14. A method of charging an energy storage device of a fluid power driven attachment to heavy equipment comprising:
receiving fluid power from a fluid power system of the heavy equipment;
operating an electric power generation device using the fluid power to provide electrical power; and
charging the energy storage device using the electrical power.

15. The method of claim 14 further comprising controlling the charging of the energy storage device by at least one of limiting an output of the electrical power and regulating an output of the electrical power.

16. The method of claim 14 further comprising controlling the operation of the electric power generation device in response to at least one of a condition of the fluid power received and an operative status of a fluid power driven device of the attachment.

17. The method of claim 16 comprising monitoring at least one of fluid pressure and fluid flow rate and turning off the electric power generation device in accordance with one or more preselected thresholds.

18. The method of claim 16 comprising operating the electric power generation device when the operative status of the fluid power driven device is idle.

19. The method of claim 14 comprising selectively controlling the fluid power to the electric power generation device, such that the fluid power is selectively directed to either one of: a fluid power driven device on the fluid power driven attachment, the electric power generation device directly, or the electric power generation device through a power generation control system.

20. The method of claim 14 wherein operating an electric power generation device comprises operating a motor and driving one of an alternator, dynamo or generator from an output of the motor.

21. A hydraulic attachment for heavy equipment wherein the hydraulic attachment receives hydraulic power from the heavy equipment, the hydraulic attachment being configured to charge a energy storage device for the hydraulic attachment via an alternator, dynamo or generator driven by a hydraulic motor using the hydraulic power received.
